(19) United States
(12) Patent Application Publication
(10) Pub. No.: US 2016/0096320 A1
(43) Pub. Date: Apr. 7, 2016

(54) METHOD AND APPARATUS FOR ADDITIVE FABRICATION OF THREE-DIMENSIONAL OBJECTS UTILIZING VESICULATED EXTRUSIONS, AND OBJECTS THEREOF

(71) Applicant: Brad Michael Bourgoyne, Baton Rouge, LA (US)

(72) Inventor: Brad Michael Bourgoyne, Baton Rouge, LA (US)

(21) Appl. No.: 14/857,647

(22) Filed: Sep. 17, 2015

Related U.S. Application Data
(60) Provisional application No. 62/059,950, filed on Oct. 5, 2014.

(51) Int. Cl. B29C 67/00; B29C 47/12; B29C 47/86; B29C 47/00

(52) U.S. Cl. CPC B29C 67/0055; B29C 47/0059; B29C 47/0042; B29C 47/128; B29C 47/862; B33Y 10/00

(57) ABSTRACT

An additive fabrication method for fabricating three-dimensional objects utilizing vesiculated extrusions, and three-dimensional objects thereof, by feeding a feedstock into an extrusion device, melting the feedstock and extruding a bead that is hollowed, aerated, or made to contain a volume of gas or liquid before solidification, and depositing and aggregating successive sections of the bead. An extrusion nozzle includes a mandrel or a tube for introducing a gas or a liquid into the melted feedstock and for forming the feedstock into an extrusion bead.

### CROSS-REFERENCE TO RELATED APPLICATIONS

This application claims the benefit of and priority to U.S. Provisional Application No. 62/059,950 filed Oct. 5, 2014, the entire contents of which is incorporated herein by reference.

### BACKGROUND

### Prior Art

The present disclosure relates to the field of extrusion-based additive fabrication. More specifically, this disclosure comprises a method and apparatus utilizing vesiculated extrusions deposited along toolpaths and aggregated to produce a three-dimensional object.

In typical extrusion-based additive fabrication processes, also known as three-dimensional printing, three-dimensional physical objects are fabricated from three-dimensional digital models. Thermoplastic material is fed into an extrusion mechanism as a feedstock, typically in the shape of a filament. This feedstock is melted and extruded through an orifice of an extruder nozzle producing an extrusion bead. This bead is deposited as the nozzle travels along a succession of computer defined toolpaths, each toolpath delineating a section of the object's form. Successive sections are aggregated to previous sections in order to create a fully three-dimensional physical version of the digital model.

In conventional three-dimensional printing, these toolpath sections are usually organized as horizontal layers, defining the boundary of each layered section with at least one perimeter and filling in the interior space with a pattern of lines. As the liquefied extrusion bead is deposited, it quickly cools and hardens, fusing with adjacent material and maintaining the shape established by the extruder. This extrusion bead can be described as the constitutive element of the object fabricated with this process. Its size, shape, position, and other characteristics define the characteristics of the object as a whole. By modifying the constitutive characteristics of the extrusion bead, the object as a whole is modified.

In conventional three-dimensional printing, a single circular orifice is typically used in the extruder nozzle. A small orifice producing a thin bead creates fine detail, but necessitates many passes of the extruder resulting in lengthy fabrication times. In order to save material, reduce fabrication time, reduce weight, and reduce distortion from warping, the interiors of the sections can be made hollow by designing them to have interior compartments. Nevertheless, a minimum amount of interior form is required for the overall strength of the object, and to provide support for overhanging toolpaths that are yet to be deposited. Also, hollows made this way require many extrusion beads. Creating even minimal interior forms with patterns produced this way necessitates a complex aggregation of numerous meandering toolpaths. A large portion of the fabrication time is inevitably dedicated to the interior area of the section even though it does not require high detail. Thus because the extruder must travel along every individual segment of toolpath in sequence, fabrication of objects larger than a few inches across using a small diameter extrusion bead can take a very long time, potentially extending to periods of longer than a full day.

In many instances, fine detail is not required for the object, especially with larger objects or objects that will be finished using secondary processes. In such cases, faster fabrication rates are more important than surface detail, and a larger extrusion bead would create an acceptable surface finish. Also, some three-dimensional printers are equipped with two extruders or two extruder nozzles, enabling the use of a second larger extrusion bead in selected sections of the toolpaths where detail is less important. Using a larger orifice in the extruder results in thicker sections created with fewer passes. However, there is a limit to how much larger a solid extrusion bead can be before the advantage of fewer required passes is outweighed by other greater disadvantages. Doubling the diameter of the extruder orifice quadruples the volume of material that must be heated and pushed through it. This larger mass of material requires a more powerful heater and feed mechanism to keep up. This larger, heavier, and more expensive extruder in turn requires a larger, heavier and more rigid positioning system. Otherwise the rate of extrusion and thus the rate of travel along the toolpath would have to be slowed to compensate. This would result in a longer fabrication time, eliminating much if not all of the advantage gained from the larger extrusion bead.

An increased demand on the mechanisms of the three-dimensional printer is not the only limit to the practical size of the solid extrusion bead. The larger mass of a larger solid bead also retains more heat longer. If the extrusion material is deposited faster than this heat can dissipate, it can cause warping or sagging of the object being made. Because thermoplastic material typically shrinks significantly as it cools, warping of the whole object will result if the surface of a thick section cools significantly faster than its core. Compensating for this greater heat energy requires slower extrusion and travel rates, or complex mechanisms for cooling, tempering, or annealing the extrusion bead.

Another consideration regarding the sizing of the extrusion bead is the wall thickness of the object. If the object is being fabricated hollow, its wall thickness can be no thinner than the width of the bead. In some cases even a wall thickness of just one large extrusion bead is many times more material than is needed for the strength of the object. In such cases, the object can be optimized for weight or for speed of fabrication but not both.

A major attraction of extrusion-based additive fabrication method is the ability to fabricate complex part geometries with speed, efficiency, and economy with relatively simple machines. Currently, these efficiencies hold true only for the manufacture of smaller scale objects. A significant demand exists for a three-dimensional printer that can print bigger and faster and inexpensively. This is in particular true for applications that use objects that will be finished using secondary processes. Consequently a need exists to provide a method which increases the speed and efficiency of current extrusion-based additive fabrication processes without sacrificing its inherent economy. This need can in part be answered by introducing a vesicular form within the constitutive extrusion bead.

### DEFINITIONS

Unless otherwise specified, the following terms as used in the present disclosure have the meanings as follows:

The terms vesicle refers to a void, hollow, or cavity formed by a volume of fluid within a volume of molten or plastic material as it hardens. In geology, a vesicle is a void that is formed when gas bubbles are trapped in molten volcanic rock as it solidifies. In biology, a vesicle is a fluid or air filled cavity or sack. The term vesicular refers to the presence of one or more vesicles, and the term vesiculation refers to the formation of vesicles.

The term extrusion bead refers to the three-dimensional physical form produced by depositing a regulated quantity of a material in a molten, semi-solid, or plastic state through an extrusion orifice along a path, and its subsequent hardening or solidification.

The term vesiculated extrusion bead refers to an extrusion bead that is hollowed, aerated, or made to contain a volume of gas or liquid before solidification.

The term vesiculating fluid refers to a gas or liquid used to displace a volume of extrusion material to create a vesiculated extrusion bead.

The term toolpath refers to a road-like path traveled by a computer controlled tool such as an extruder to fashion physical material into a section of a three-dimensional object.

### SUMMARY

The embodiments of the present disclosure comprise a method and apparatus for utilizing vesiculated extrusions in extrusion-based additive fabrication. One or more vesicular forms are created within the extrusions by occupying a portion of the extrusion bead with a vesiculating fluid in order to optimize the fabrication of an object and to improve its ultimate physical characteristics. This vesiculation is produced by a means including but not limited to hollowing, aerating, or otherwise introducing gas or liquid bubbles into the extrusion bead before it solidifies. Creating at least one vesicle within each extrusion bead reduces the amount of material used to create a bead of a given size. This allows a larger bead to be extruded faster than if solid, and produces a more resilient and more stable bead. The reduced mass of a vesiculated extrusion bead holds less heat and cools faster and more evenly than a solid extrusion bead of the same size. The object resulting from the aggregation of such extrusion beads requires substantially less time and material to make, weighing less as a final product. By varying the volume of vesiculating fluid within the extrusion material, the final diameter of the extrusion bead can be varied, making it less dependent on the physical size of the extruder orifice. Thus, one nozzle can be used to produce extrusion beads of variable size and overall density.

An embodiment of this disclosure uses an extruder nozzle which is enlarged relative to a conventional nozzle orifice and which is fitted on a typical three-dimensional printer. A hollow cylindrical mandrel is located in the center of the nozzle, and air is supplied as the vesiculating fluid and is pumped into the bead through the mandrel. The extrusion material flows around the mandrel to form the walls of a hollow, thin-walled, tubular vesicle in the extrusion bead. This tubular vesicle is maintained by the pressure of the supplied air until the bead cools and solidifies. The flow of air into the tubular vesicle has the additional effect of annealing the extrusion bead as it is made. The extrusion bead is deposited by the conventional three-dimensional printer in the same manner as a solid extrusion bead.

Mother embodiment of this disclosure uses a solid mandrel in the extruder nozzle orifice and ambient air as the vesiculating fluid to create a hollow tubular extrusion bead. As the mandrel forms the walls of a tubular bead, air enters the bead through openings in the bead itself. These openings are created by interrupting the flow of the extrusion material as the nozzle travels the toolpath.

Another embodiment of this disclosure comprises an extruder nozzle with an internal hollow mandrel fashioned with a passage that connects ambient air exterior to the nozzle to the interior of the extrusion bead through the mandrel. In this configuration, the mandrel forms the walls of the vesicle, while the air acts as the vesiculating fluid and is drawn in through the hollow mandrel to fill the vesicle.

Other embodiments of this disclosure provide for configurations that use the vesiculating fluid to both form and fill the vesicles. The vesiculating fluid is introduced at locations in the extruder assembly, including within the nozzle body or within the nozzle orifice. Further embodiments provide for means of dispersing the vesiculating fluid and distributing it within the extrusion material.

Another further embodiment provides for controlling the extrusion bead size and density through the control of conditions of the vesiculating fluid, coordinated with control of the conditions of the extrusion material, and with the extruder assembly velocity. Use of a variable bead size allows for optimization of object detail, material use, strength-to-weight ratio, and fabrication time.

Another further embodiment provides for a means to control the temperature of the vesiculating fluid in order to regulate the speed and manner in which the vesiculated extrusion bead cools and solidifies. Such control can facilitate creation of special formations of the extrusion bead that would not be otherwise practical, such as freestanding, overhanging, or bridging forms without additional support structures.

Other embodiments provides for the use of a gas other than air, and for the use of water or other liquid as a vesiculating fluid.

Other embodiments provide for the use of a physical or chemical blowing agent to produce the vesiculating fluid. Blowing agents are sometimes referred to as foaming agents.

Further embodiments provide for introducing the vesiculating fluid with the feedstock, or for including vesicular bodies or chemical or physical blowing agents in the feedstock itself. These and other aspects of the present invention will be more fully understood by reference to the following detailed description herein.

### BRIEF DESCRIPTION OF THE DRAWINGS

FIG. 1 illustrates types of vesiculated extrusion beads as discussed in the present disclosure;

FIGS. 2A and 2B are illustrations of prior art, including top, front, perspective detail views of a conventional section of aggregated solid extrusion beads and a hollowed wall section aggregated from small solid extrusion beads in a “honeycomb” pattern;

FIG. 3 provides a comparison of cross-sections of prior art solid extrusion beads and of an embodiment vesiculated extrusion bead;

FIGS. 4A and 4B are top, front, perspective detail views of a section of aggregated vesiculated extrusion beads and a section of aggregated large vesiculated extrusion beads used in conjunction with small solid extrusion beads;

FIG. 5 is a top, front, perspective view of a typical extrusion-based additive fabrication system suitable for implementing embodiments of the present disclosure and indicates the inclusion of some embodiment components;

FIG. 6 is a bottom, front, perspective view of one embodiment that utilizes a mandrel located in the extruder nozzle to form a vesiculated extrusion bead;

FIG. 7A is a cross-sectional detail view the embodiment of FIG. 6;

FIGS. 7B and 7C are cross-sectional detail views of other embodiments that utilize a mandrel located in the extruder nozzle to form a vesiculated extrusion bead;

FIG. 8 is a cross-sectional detail view of an embodiment that utilizes a plurality of mandrels located in the extruder nozzle to form a vesiculated extrusion bead;

FIGS. 9A and 9B are cross-sectional detail views of other embodiments that utilize a vesiculating fluid to both form and fill vesicles in an extrusion bead;

FIGS. 10A and 10B are cross-sectional detail views of further embodiments that disperse and distribute the vesiculating fluid within the extrusion material before it is extruded through the extruder orifice;

FIGS. 11A and 11B are cross-sectional detail views of a further embodiment that controls the size and density of the extrusion bead produced by an extruder orifice of a fixed size through the variable control of the conditions of either the vesiculating fluid or of the extrusion material or of both.

FIG. 12 is a cross-sectional detail view of another embodiment that utilizes an endothermic blowing agent introduced as a part of or along with the feedstock and that is activated by a rapid response heater element at the nozzle orifice.

### DETAILED DESCRIPTION

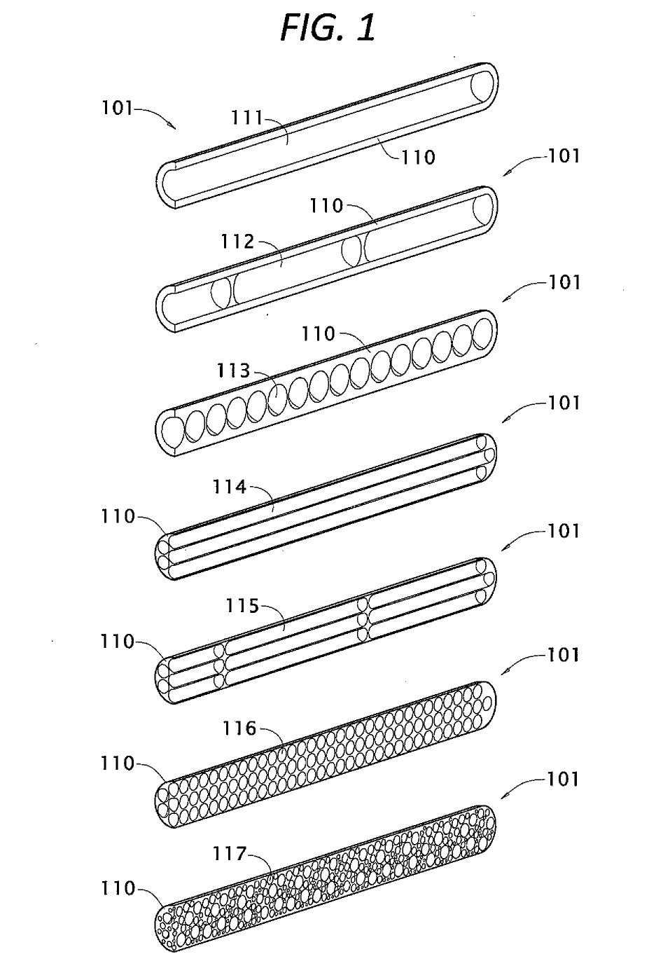

Referring now to the drawings, FIG. 1 illustrates various types of vesiculated extrusion beads 101, each containing a different type of vesicle form that can be produced and utilized with the embodiments of this disclosure. Each vesiculated extrusion bead 101 comprises a wall of extrusion material 110 surrounding a vesicular form 111-117 containing a gas or liquid. These vesicular forms include a tubular vesicle 111, a series of elongate vesicles 112, a series of spheroidal vesicles 113, a bundle of mini-tubular vesicles 114, a series of bundles of mini-elongate vesicles 115, a series of regular mini-spheroidal vesicles 116, and a random arrangement of randomly-sized mini-spheroidal vesicles creating a vesicular texture 117.

These vesiculated extrusion beads are produced with an extruder nozzle with a conventionally circular orifice, whereby interior voids are created according to means outlined in this disclosure. These voids, referred to here as vesicles, are created while the extrusion material is molten or in a semi-solid state. The vesicles are created through the displacing action of a mandrel within the nozzle orifice, by that of a vesiculating fluid, or through a combination of the two. Because the outer form of the vesiculated extrusion bead is substantially the same as that of a conventional solid extrusion bead, it can be used to make an object in a conventional manner. Both tubular and bubble-like forms efficiently occupy the cylindrical shape of the extrusion bead. The amount of material used to create the walls of the vesicle are determined by the specific configuration of the embodiment used to create them, allowing for a significant degree of optimization for material usage versus part strength. The hollow forms permit even cooling of the extrusion bead as they create additional surface area and eliminate a solid core that retains heat. Additional control of the bead cooling can be affected by controlling the temperature of the vesiculating fluid. Cooler interior hollows would provide a stiffer internal structure while a still hot exterior surface remained pliable and fusible.

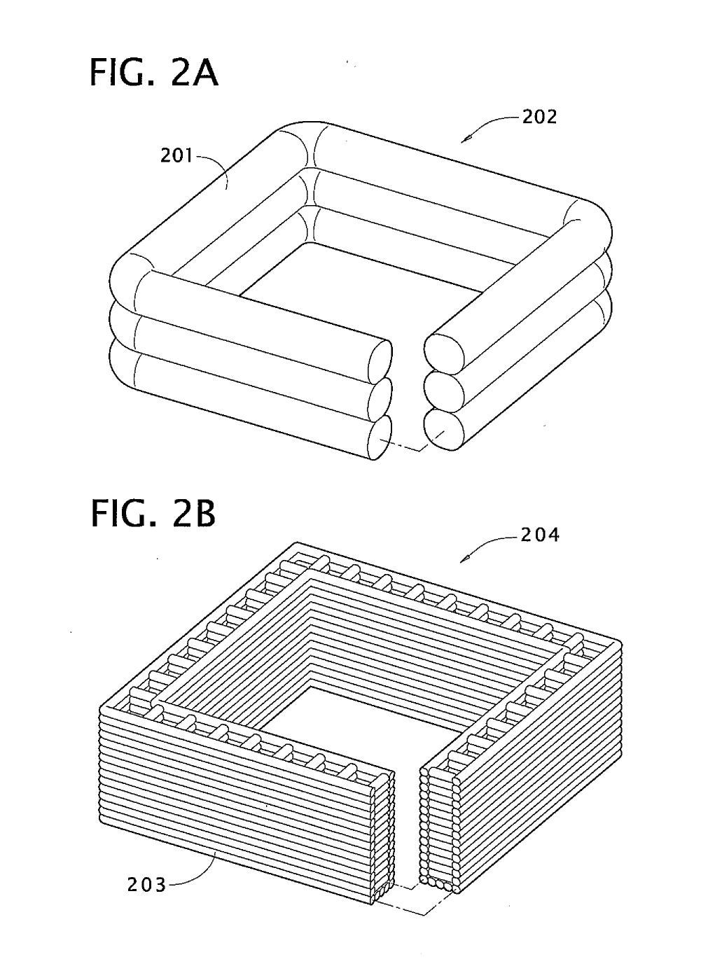

FIG. 2A illustrates prior art solid extrusion beads 201 as the constitutive element in conventional three-dimensional printing. In this example, the object is being fabricated as a hollow object with a wall thickness of a single toolpath defining the perimeter of the object. In conventional three-dimensional printing, a line of extruded thermoplastic material is deposited along a toolpath as a solid extrusion bead 201. As the bead 201 is extruded, it quickly cools and hardens, fusing with adjacent material to create aggregate section 202. Subsequent sections are likewise extruded as solid beads and aggregated into the object as a whole. The size and shape of the solid extrusion bead 201 is established by the size and shape of the extruder nozzle and by the spacing between the toolpaths.

The possible thickness of each layered section and the width of the bead are dependent on the diameter of the orifice. Both the fineness of detail achievable on the outer surface of the object and the time required to make the object is determined by the size of the extruder orifice. A small orifice producing a small solid extrusion bead 203 (FIG. 2B) creates fine detail, but requires many more passes of the extruder than a larger bead 201, resulting in much longer fabrication times. Objects can be designed hollow to optimize part weight and reduce fabrication time, but a minimum wall thickness is defined by the bead diameter. Larger extruder orifices can be used to create larger extrusion beads 201, but there is a limit to how big a given three-dimensional printer can effectively print a solid bead. There is also a limit to how fast a large solid extrusion bead 201 can be deposited without it beginning to sag or warp. Ultimately, larger solid extrusion beads usually require slower extrusion rates. Furthermore, a solid extrusion bead cannot directly incorporate hollows as part of the constitutive element of the object.

FIG. 2B illustrates a prior art technique of using a small solid extrusion bead 203 aggregated in a “honeycomb” section 204 of the object. Using a small solid extrusion bead 203 allows for better surface detail, while creating cavities by extruding an elaborate network of toolpaths reduces the overall material used. The weight of the object can be thus reduced without compromising its strength. This technique creates an object with “honeycombed” walls. Such an object would be well suited for use as a pattern in the lost-pattern process of metal casting for example. However, while this technique requires significantly less material and time than creating the object solid, it still requires that both the outside and inside and all the walls of the interior cavities be created with the same small extrusion bead 203. This results in long, meandering toolpaths and therefore long print times. Even in this optimized configuration, more than half the print time is spent inside the interiors, which are not directly visible.

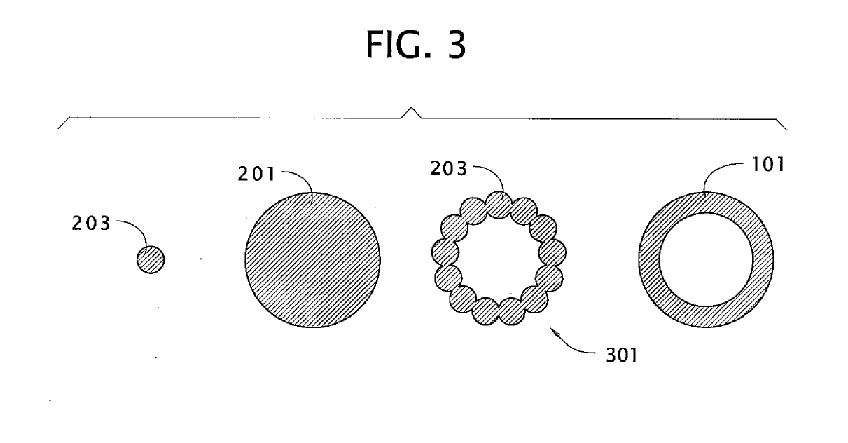

FIG. 3 illustrates a comparison of cross-sectional views of prior art solid extrusion beads 203 and 201, and an embodiment vesiculated extrusion bead 101 as presented in this disclosure. In this example illustration, small solid extrusion bead 203 is shown as having a diameter of one unit, compared to large solid extrusion bead 201, aggregate 301 of small solid extrusion beads 203, and large vesiculated extrusion bead 101 shown having comparative diameters of five units. At these relative sizes, large solid bead 201 would have a cross-sectional area approximately twenty-five times that of small solid bead 203. This means that in extruding a section five times as thick, large bead 201 would require approximately twenty-five times the material to pass through the extruder at once. Aggregate 301 of small solid beads 203 making up a hollow cross-section the same size as large bead 201 would require approximately thirteen such beads. Aggregate 301 would require approximately thirteen times the toolpath length to be traveled, but use approximately half the material of large solid bead 201. These three configurations are possible with prior art.

Vesiculated extrusion bead 101 is typical of the bead used in the embodiments of this disclosure. In this example it is the same size as large solid bead 201 but uses about half the material, so it can be extruded at least twice as fast using the same extruder. It also has sixty-nine percent more surface area, so it will cool substantially faster and more evenly. Vesiculated bead 101 also uses the same amount of material as aggregate 301, but requires only one toolpath compared to thirteen needed to extrude aggregate 301. Vesiculated beads 101 made with thinner walls using even less material can be extruded even faster.

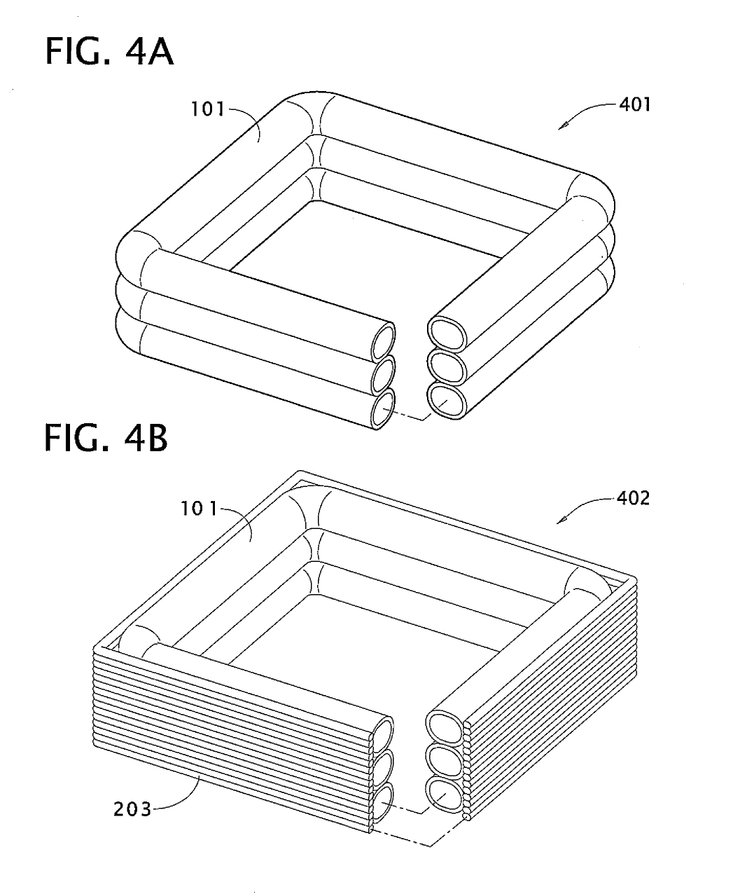

FIG. 4A illustrates a series of vesiculated extrusion beads 101 deposited in layered toolpath sections to create aggregated section 401 of an object, equivalent to aggregated section 202 created using solid bead 201 (FIG. 2A). As in section 202, the object is being fabricated as a hollow object with a wall thickness of a single toolpath defining the perimeter of the object. The illustration shows a tubular vesiculated extrusion bead 101, but any vesicle form could be used depending on the embodiment. Had this object been made with solid extrusion beads rather than tubular vesiculated extrusions 101 shown, the walls would necessarily be made solid rather than hollow. This would require a great deal more material and result in a much heavier object. If this object was to be used as a pattern for lost-pattern casting, the vesiculated version would contain less material to remove during the burning-out process, saving fuel, time, and expense.

FIG. 4B illustrates a combination of beads used to create aggregate section 402. Here, small solid extrusion bead 203 is used to define the detail of the surface of the object, while large vesiculated extrusion bead 101 defines the bulk of the object's interior. In this instance, vesiculated extrusion bead 101 is five times larger than small solid extrusion bead 203, thus for every five solid beads 203 deposited, a single large vesiculated bead 101 is deposited adjacently. Using a similar amount of material as “honeycombed” aggregate section 204 in FIG. 2B, combination aggregate section 402 will require only one third the toolpath distance traveled. Thus it would potentially reduce fabrication time by two thirds or more.

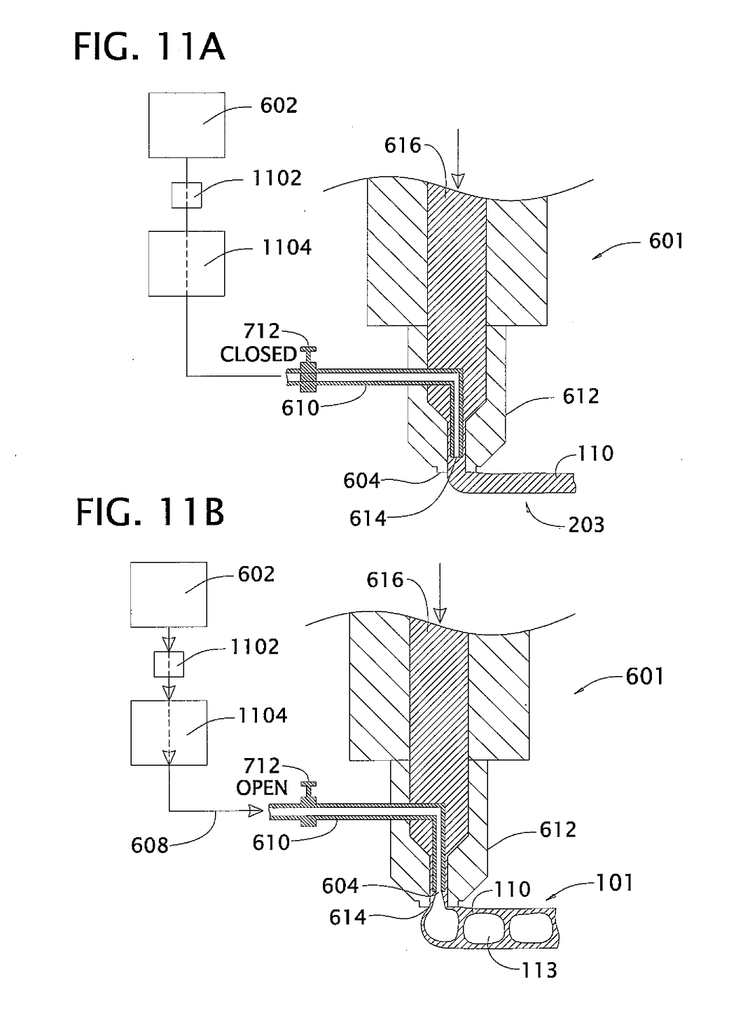

This combination of extrusion beads could be accomplished by using a conventional three-dimensional printer equipped with two extruders with differently sized nozzles, or one extruder that can selectively extrude through two differently sized nozzles. In either case, one nozzle would create the vesiculated extrusion beads discussed in this disclosure. This combination of beads is also possible with an embodiment as illustrated in FIGS. 11A and 11B that provide for variable control of the extrusion bead size and density. Therefore, through the use of at least one of the embodiments outlined in this disclosure, an object can be made with a combination of small solid and large vesiculated extrusion beads using much less material in much less time while still achieving similar detail as a conventional configuration using solely a small solid extrusion bead.

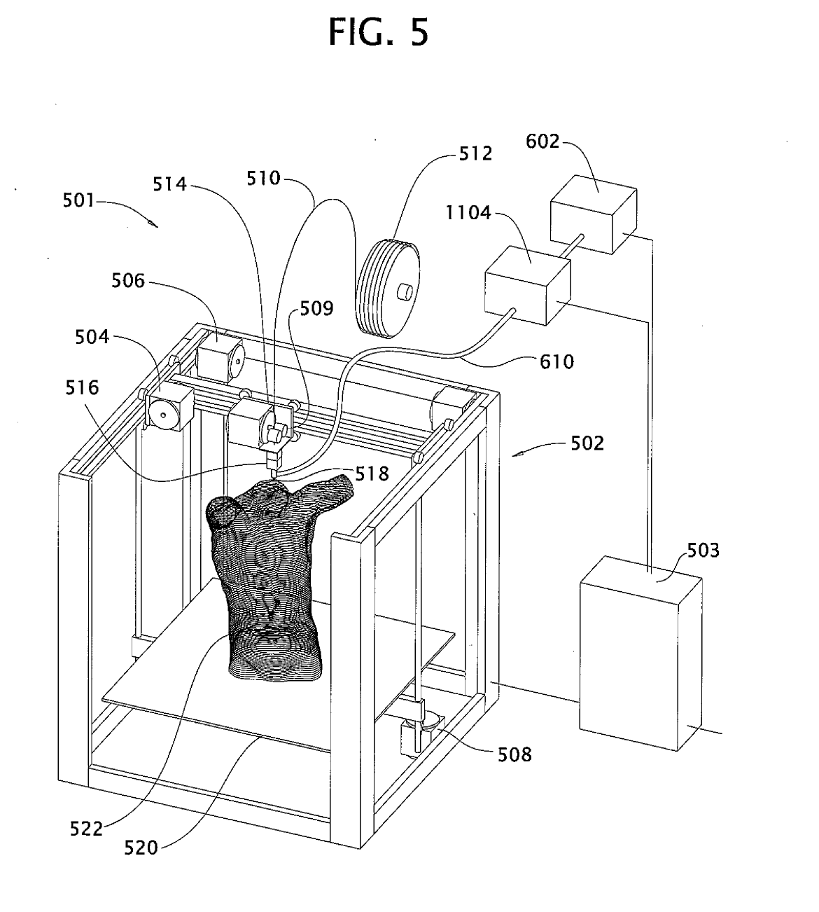

FIG. 5 illustrates a typical additive fabrication apparatus 501 as configured to implement some embodiments of the present disclosure. However, the types and kinds of extrusion-based additive fabrication apparatus with which embodiments of this disclosure could be implemented are not limited to the illustrated apparatus 501. Virtually any extrusion-based additive fabrication apparatus could be used as the platform for the embodiments. Indeed, these embodiments could also be operated as stand-alone handheld tools to manually create objects with vesiculated extrusion beads without the use of a three-dimensional printer or other positional control apparatus.

Apparatus 501 includes a computer-controlled positioning device 502 utilizing x-axis positioning mechanism 504, y-axis positioning mechanism 506, and z-axis positioning mechanism 508 which positions a heated extruder assembly 514. Connected to assembly 514, an extruder drive mechanism 509 feeds a thermoplastic feedstock 510 in the form of a filament from a spool 512 through heated extruder assembly 514 according to commands sent by a controller 503. Feedstock 510 becomes heated thermoplastic extrusion material which is extruded through an extruder nozzle 516 through a small extrusion orifice as an extrusion bead 518 onto a build platform 520, delineating layered sections of a digital model to fabricate a physical object 522. The molten thermoplastic extrusion material quickly cools and hardens, fusing first with build platform 520 and then with subsequent layered sections. Upon completion of a layered section, z-axis positioning mechanism 508 moves build platform 520 and object 522 relative to extruder assembly 514 to prepare it for receiving the next section of material. The process is continued in this fashion until object 522 is formed in its entirety.

The apparatus 501 is of the type typically referred to as a Cartesian-style three-dimensional printer. Other similar printers, as well as those described as Delta-style, SCARA-style, and many others, are suitable for implementing the embodiments of this disclosure. Furthermore, although these and other conventional three-dimensional printers typically build the object as horizontal layered sections, these sections need not be constrained to planar or horizontal sections. Indeed, any additive fabrication apparatus that is based on the process of extruding material along toolpaths are appropriate for the embodiments, regardless of the specific geometries utilized.

Components in FIG. 5 including vesiculating fluid source 602, temperature control apparatus 1104, and tube 610, are embodiment components added to the otherwise typical three-dimensional printer apparatus 501 to implement some embodiments of this disclosure.

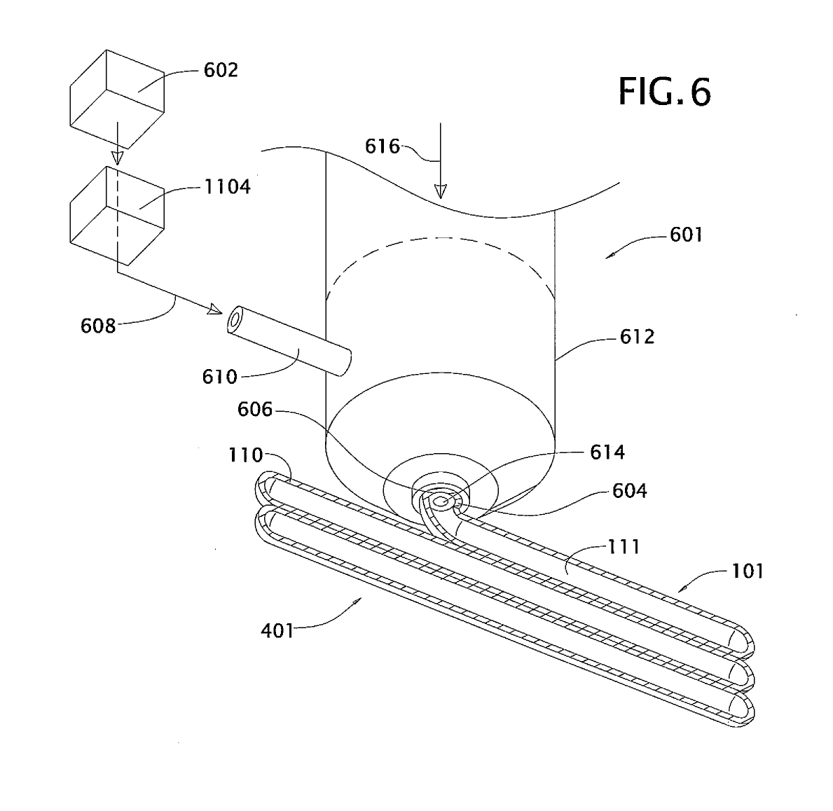

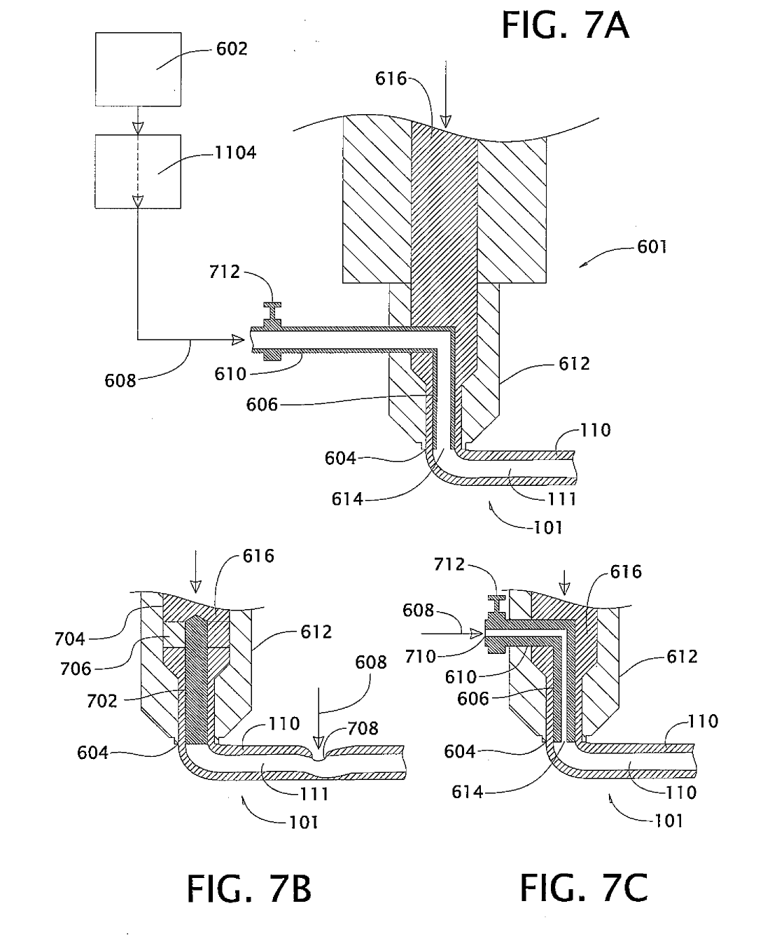

FIG. 6 is a bottom, front, perspective view of an embodiment extrusion nozzle 601, which replaces the extrusion nozzle 516 in apparatus 501 (FIG. 5). The illustration in FIG. 7A is a cross-section view of the same embodiment. This embodiment is implemented with a typical conventional three-dimensional printer 501 such as is illustrated in FIG. 5, with embodiment components comprising nozzle 601, an air pump as a vesiculating fluid source 602, and tube 610.

In this embodiment, molten thermoplastic extrusion material 616 is fed into nozzle 612 and out through a small circular nozzle orifice 604 to produce extrusion bead 101. Orifice 604 is larger than is typical, and a hollow mandrel 606 is located in its center. An air pump 602 feeds air as vesiculating fluid 608 through a tube 610 extending through nozzle body 612 to a port 614 in the center of mandrel 606. The molten thermoplastic extrusion material 616 flows through nozzle body 612 and around mandrel 606, creating a hollow tubular extrusion bead 101 which is held open or slightly inflated by air 608 exiting through port 614.

In this embodiment the displacing action of mandrel 606 and air 608 work in conjunction to create the vesicles in the extrusion bead. Mandrel 606 mechanically displaces extrusion material 616 to form it into vesicle walls 110, and vesiculating fluid (air) 608 holds tubular vesicle 110 open until solidification. This air 608 is pumped through mandrel 606 in a continuous manner. Bead 101 is started and stopped with the flow of thermoplastic extrusion material 616 from extruder assembly 514 as in a typical three-dimensional printer. Bead size is held generally constant with low, steady air pressure. This produces a thin-walled tubular bead 101 comprised of substantially less material compared to a solid bead of the same diameter, requiring substantially less heat input. This hollow bead is fast cooling and stable, and can be deposited in the same manner as a conventional solid bead. In instances where one bead is laid in too close proximity to another, the hollow void allows the bead to be compressed and not result in an excess of material building up. The air pressure can be set to cause the bead to slightly overinflate in instances where the bead is laid down too far from another bead to normally fuse, allowing it to grow until it makes contact with the other bead. This over-inflation allows overhanging forms to be more successfully created without additional support.

Vesiculating fluid source 602 could comprise a fan, a blower, a pump, or a pressurized supply vessel. Vesiculating fluid 608 could comprise another gas, or water or another liquid. Should the fluid 608 be a liquid, source 602 could be a pump or a gravity-feed supply vessel. Means of controlling vesiculating fluid source 602 could be an independent electromechanical device such as but not limited to a switch or a potentiometer, or it could be controller 503 in apparatus 501 (FIG. 5).

FIG. 7B illustrates another version of this embodiment. A mandrel spider 706 holds a solid mandrel 702 in the center of nozzle chamber 704 without blocking the flow of extrusion material 616. In this embodiment air acts as vesiculating fluid 608 supplied by ambient air flowing into tubular vesiculation 111 through gaps 708 in vesicle walls 110. These gaps 708 are created by intermitted interruptions in the flow of molten extrusion material 616 as extruder assembly 516 continues to travel along its toolpath. The resulting breaks in extrusion material 616 create gaps 708 in the tubular vesicle wall 110. While this embodiment creates relatively short tubular segments, this is sufficient for many applications; furthermore, it can be implemented on virtually any three-dimensional printer that will accept custom nozzles.

FIG. 7C illustrates an alternative embodiment similar that of FIG. 7A in that it too makes use of hollow mandrel 606 in nozzle 612 extending into orifice 604. In this embodiment, tube 610 is open to the exterior of nozzle body 612 through port 710 into which ambient air can be drawn into tube 610 as vesiculating fluid 608. The mechanical action of mandrel 606 displacing extrusion material 616 to form vesicle walls 110 creates a low pressure region which draws in ambient air 608 to fill tubular vesicle 110. As with the embodiment of FIG. 7A, this embodiment can create continuous vesiculated extrusion beads. Like that of FIG. 7B, it can be implemented on virtually any three-dimensional printer that will accept custom nozzles.

Embodiments with a single mandrel will produce a single vesicle form in sequence within the extrusion bead 101. Each of the embodiments in FIGS. 7A, 7B, and 7C will create tubular vesicle forms 111; however, a means to stop and start the flow of the vesiculating fluid, or reverse the flow with negative pressure, can be provided to produce modulated elongate vesicle forms 112, and spheroidal vesicle forms 113. Such means can be provided in the embodiments of FIGS. 7A and 7C in the form of a valve 712 that can intermittently open and close tube 610. In the case of the embodiment in FIG. 7A, a means to turn vesiculating fluid source 602 on and off will provide that function. A means to reverse the flow from source 602, such as through the action of a reversible pump, would likewise provide this function. Means to control at least valve 712 or fluid source 602 can comprise an electromechanical device such as but not limited to a solenoid controlled independently or by controller 503 of apparatus 501 (FIG. 5), or a solely mechanical device integrated into extruder assembly 514 (FIG. 5). For example, this mechanical device could comprise a cam operated flow interrupter driven by the extruder drive 509. Should fluid source 602 be a type of pump that produced a pulsating flow, such as that of a piston or peristaltic pump, these pulsations could be designed to produce the desired modulated vesicular forms. Such a pump driven by a stepper or servo motor controlled by computer controller 503 would provide very precise control of both positive and negative pressure pulses and volumes of vesiculating fluid 608.

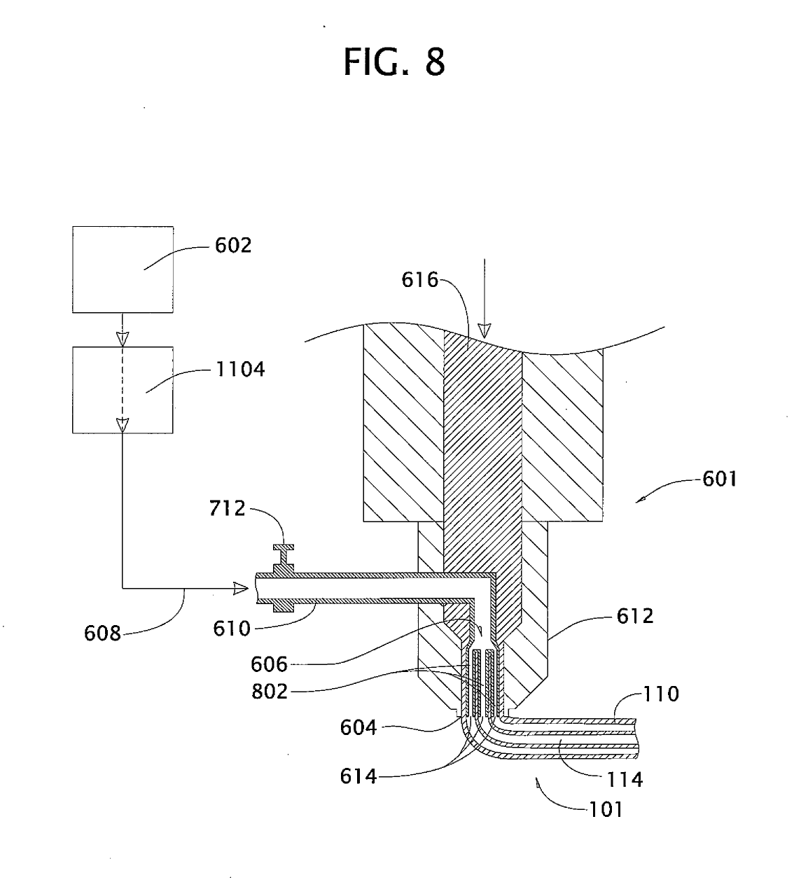

A further variation of an embodiment using at least one mandrel is shown in FIG. 8. Otherwise similar to the embodiments illustrated in FIGS. 7A, 7B, and 7C, this embodiment includes a plurality of mandrels 802 that divide extrusion material 616 into an equivalent number of mini-tubular 114, mini-elongate 115, or mini-spheroidal 101 vesicle forms. As with the single mandrel configuration, the multi-mandrel configuration would function with solid mandrels and no ports (corresponding to FIG. 7B), as well as with hollow mandrels with ports 614 drawing in ambient air as vesiculating fluid 608 (corresponding to FIG. 7C).

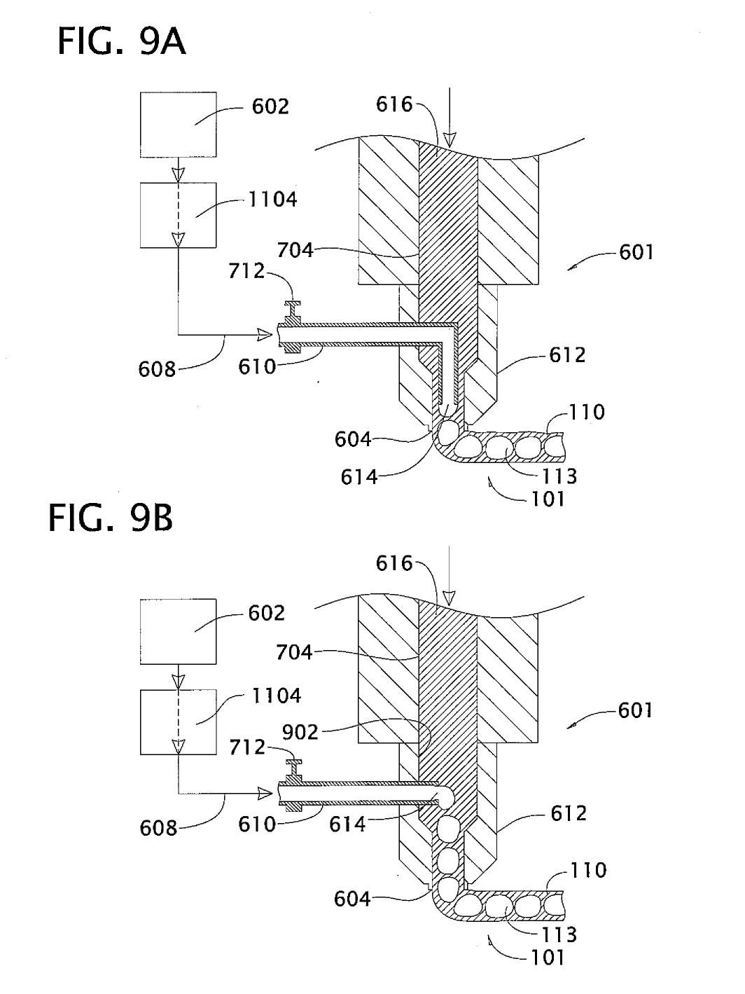

A mandrel is not the only means by which an extrusion bead can be vesiculated. FIGS. 9A and 9B illustrate alternative embodiments in which vesiculating fluid 608 both forms and fills the vesicles in the extrusion bead. Accordingly, vesiculating fluid 608 is introduced through tube 610 into molten extrusion material 616 within extrusion nozzle 612, displacing a volume of the extrusion material 616 before it is formed into an extrusion bead. In the embodiment illustrated in FIG. 9A, tube 610 extends down through nozzle chamber 704 towards its exit at the orifice 604. In this configuration, tube 610 may act to some degree like a mandrel, but the primary displacing action is created by vesiculating fluid 608 as it is introduced inside nozzle 612. Modulating the flow of vesiculating fluid 608 will modulate the vesicle form produced, whether tubular 111, elongate 112, or spheroidal 113. Means to modulate the flow of vesiculating fluid 608 in this embodiment can comprise the same means described in the previous embodiments.

FIG. 9B shows a similar configuration in which port 614 is located in a side 902 of nozzle chamber 704. In this location, vesiculating fluid 608 is introduced with enough pressure to overcome the pressure exerted by the extruder pushing extrusion material 616 into nozzle chamber 704. Introducing vesiculating fluid 608 at this location provides more opportunity to modify the size and distribution of the vesicles formed, but requires greater pressure to displace the molten extrusion material 616.

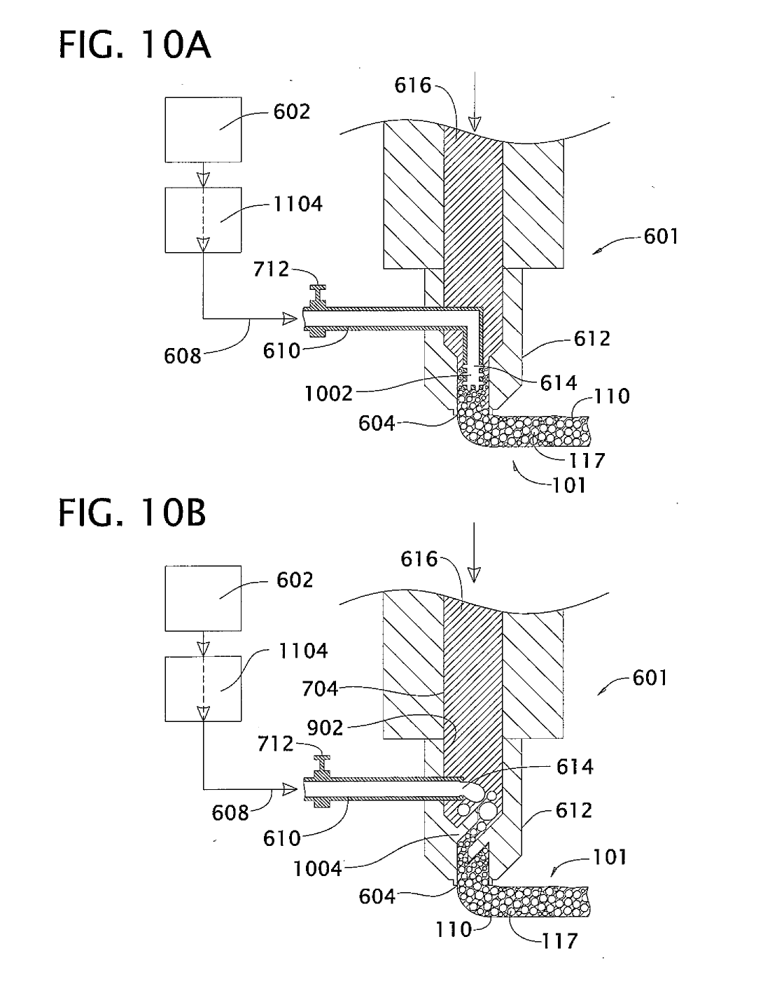

FIG. 10A illustrates an alternate embodiment similar to that of FIG. 9A which includes a plurality of ports 614, which would break the flow of vesiculating fluid 608 into a continuous stream of mini-spheroidal vesicles 117, producing an extrusion bead 101 that is composed of a vesicular texture 117. This plurality of ports 614 could be in the form of an aerator nozzle 1002, comprising but not limited to a perforated cap, a mesh, a mat, a screen, or a porous matrix. FIG. 10B illustrates an alternative embodiment including a mixing chamber 1004 inside nozzle chamber 704 that would break apart the flow of vesiculating fluid 608 and distribute it in extrusion material 616 before it exited orifice 604. This mixing chamber comprises a region of nozzle chamber 704 between port 614 and orifice 604 which is configured to modify the distribution and size of the bubbles of vesiculating fluid 608 within extrusion material 616. The embodiments of FIGS. 10A and 10B comprise methods and means to further modify vesiculating fluid 608 within extrusion material 616 in order to control the kind, size, number, and distribution of the vesicular forms within vesiculated extrusion bead 101.

Except in embodiments specified as using ambient air supplied from the ambient environment, vesiculating fluid 608 could comprise another gas, such as but not limited to carbon dioxide; a liquid, such as but not limited to water; or produced by a chemical blowing agent, such as but not limited to sodium bicarbonate. Water would have particularly useful application as a vesiculating fluid, as it could function both in its liquid form to displace extrusion material, as well as in its gaseous form as steam. For example, water could be introduced into the hot extrusion material as a liquid, quickly being turned into steam by the heat of the extrusion material and thereby producing bubbles.

FIGS. 11A and 11B illustrate a further alternative variation similar to that of FIG. 9A in which the conditions of vesiculating fluid 608 are coordinated with the conditions of extrusion material 616 to control at least the diameter or density of the extrusion bead. These conditions include at least one or a combination of temperature, pressure, and flow rate. In this embodiment, port 614 is located within extruder nozzle 612 close to or in orifice 604. The outermost edge of port 614 is set back inside the outermost edge of orifice 604 far enough to allow extrusion material 616 to flow out of orifice 604 as a solid bead. Orifice 604 is sized to be as small as the smallest desired extrusion bead diameter. Preventing the flow of vesiculating fluid 608 by closing tube 610 by means of valve 712, or by turning off source 602, allows a solid extrusion bead 203 to be produced with the diameter of the orifice as in FIG. 11A. Introducing the flow of vesiculating fluid 608 by means of opening valve 712 or by turning on source 602 allows a vesiculated extrusion bead 101 to be produced as in FIG. 11B. The size of the vesiculated extrusion bead 101 produced depends on the temperature, rate, and pressure of vesiculating fluid 608, combined with the temperature, rate, and pressure of extrusion material 616, as well as the velocity of extruder assembly 514. Controlling some or all of these conditions provides control of the diameter and density of the resulting bead. For example, high pressure in vesiculating fluid 608 would result in a bead 101 that balloons larger than the orifice diameter. This control would allow the creation of variable extrusion bead diameters with a single fixed-size orifice. Areas of high detail, such as in outer perimeters, would be extruded with a small solid bead 203 (FIG. 11A), while a large vesiculated bead 101 would be used in areas of bulk infill and support (FIG. 11B). This combination of bead sizes facilitates a higher speed of fabrication and a reduction in the amount of material used while still attaining high detail in areas of importance. Objects made with this embodiment would be particularly suitable for use as patterns in lost-pattern, and evaporative-pattern casting of metal parts.

In this embodiment, the rate of vesiculating fluid 608 could be controlled by means of controlling either source 602 or valve 712 or both. The pressure of fluid 608 could be controlled by means of control of source 602 or of an electromechanically controlled pressure regulator 1102. The temperature of fluid 608 could be controlled by a temperature control apparatus 1104. All of these means of control would be themselves controlled by controller 503 of apparatus 501 (FIG. 5) such that the conditions of the vesiculating fluid 608 would be coordinated with the conditions of extrusion material 616, and the rate of extrusion, and the velocity of extruder assembly 514.

Controlling the temperature of vesiculating fluid 608 prior to introducing it to extrusion material 616 would provide some measure of control over the temperature of the interior of extrusion bead 101 as it is deposited. Cooling vesiculating fluid 608 would cause the interior of extrusion bead 101 to solidify more quickly from the inside out. Such cooling would impart a degree of rigidity to extrusion bead 101 as it is being formed, while allowing the outer surface to remain pliable and tacky. This would enable it to fuse with adjacent forms while also gaining enough rigidity to support itself. Self-supporting, free-standing, and bridging extrusion beads could be formed with a single point of attachment and without needing additional temporary support. Temperature control apparatus 1104 would consist of an arrangement or combination of at least one of the following group of devices: a fan, pump, heat sink, heat pipe, water chiller, refrigeration unit, thermoelectric cooling device, or heater. Apparatus 1104 is shown in the figures as a separate assembly downstream to vesiculating fluid source 602, but it could be integrated into source 602 or be located upstream of it. If apparatus 1104 were comprised of an electromechanical device, its means of control could be provided independently or by controller 503 of apparatus 501 (FIG. 5) as in the previous embodiment.

Another alternative embodiment uses a conventional extruder assembly 514 and nozzle 516, and provides for the inclusion of vesiculating fluid 608 with feedstock 510, for example as a part of a filament, or introduced along with it. Preformed vesicular forms including hollow tubes, elongates, or spheroids could be included in feedstock 510 and incorporated into extrusion bead 101. A physical or chemical blowing agent such as water or sodium bicarbonate could be included with feedstock 510. This blowing agent could be mixed into the feedstock during its manufacture, or added as a coating or as a core. Gas bubbles could be dissolved in feedstock 510 during its manufacture, ready to expand out of solution when heated in the extruder and extruded from nozzle 516. If manufactured as a standard size filament, such feedstock could be used in most typical existing three-dimensional printers without significant modification of the existing equipment. This would be especially useful for use with three-dimensional printers already equipped with dual extruders, as the secondary extruder could be used with this filament for fabricating the inner perimeters, infill, and support with a large vesiculated extrusion bead 101, while the primary extruder would be used for fabricating the outer perimeters using a small solid extrusion bead 203 and a standard filament.

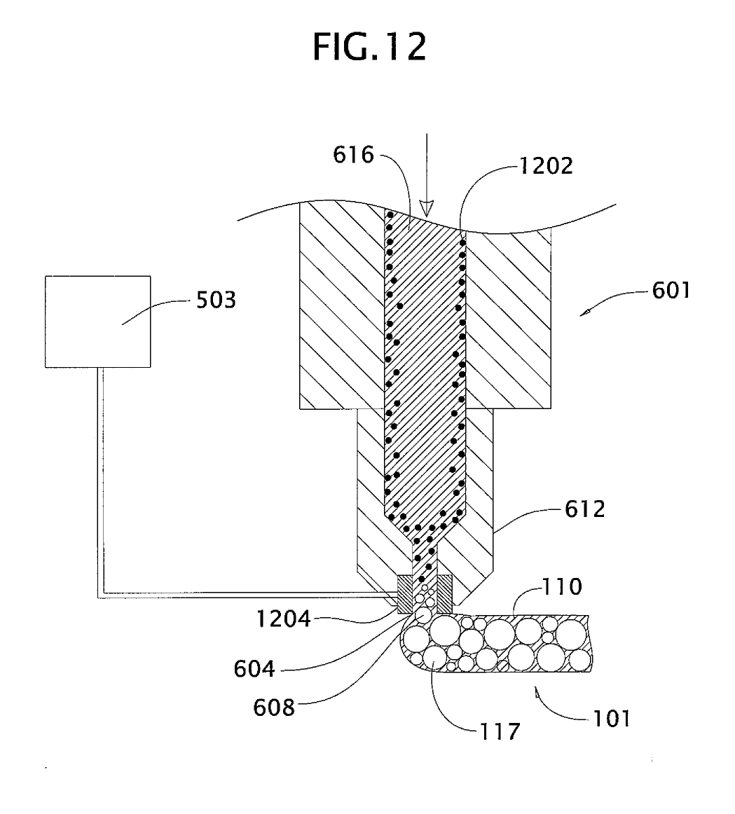

FIG. 12 illustrates a further embodiment in which an endothermic blowing agent 1202 would be introduced as a part of feedstock 510 (FIG. 5) or alongside extrusion material 616. Blowing agent 1202 would be formulated to activate at a temperature above the standard extrusion temperature of extrusion material 616 to produce a vesiculating fluid 608. In this case, selective control over whether the extrusion bead was formed solid or vesiculated could be achieved by means of setting the temperature of the extruder. Furthermore, by controlling the temperature, the amount of vesiculation and thus the size and density of the bead could be controlled. This selective control could be further facilitated by the addition of a rapid-response heating element 1204 located at the orifice 604. Heating element 1204 would be an electric resistance device such as a graphite electrode which would generate heat quickly but would not retain heat after being turned off. Thus heating element 1204 could rapidly elevate the temperature of the extrusion material 616 as it exited the nozzle 601, activating blowing agent 1202 to produce rapidly expanding bubbles of vesiculating fluid 608. These bubbles would expand to create a vesiculated extrusion bead consisting of vesicular texture 117. This rapid-response heating element would be controlled by controller 503 of apparatus 501 (FIG. 5) to coordinate when the bead was to be solid and when it was to be vesiculated. Thus a combination of bead sizes and densities could be utilized selectively in fabricating the object and support sections.

An advantage facilitated by all of these embodiments is the use of vesiculated extrusion beads to create temporary supports that are designed to be either substantially weaker or faster printing than the primary permanent sections of the object being fabrication, or both. Often, sections of the object require additional support in order to be fabricated properly. This support is provided by additional sections of extrusion beads that are removed from the object after fabrication. These support sections can add a significant amount of time and material to the process. Their removal adds yet more time, as does any repair or refinishing of the object's surface where they were joined. Fabricating these support sections out of highly vesiculated extrusion beads would make them extrude faster. They would also be made weaker than the primary sections and thus easier to remove. If these supports were made of a material that can be dissolved, as some support material is specially formulated to do, the hollow vesiculated extrusion beads would speed up the dissolving process. As mentioned before, selectively using vesiculated extrusion beads can be achieved by the use of a three-dimensional printer equipped with at least two nozzles, where one nozzle is configured to implement one of the preceding embodiments. Furthermore, a printer with a single nozzle that implemented an embodiment that provided for a variable extrusion bead would be especially effective at facilitating this optimization.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of forming an object by additive fabrication comprising the steps of:
conveying feedstock into an extrusion mechanism;
melting the feedstock; and
extruding a vesiculated extrusion bead out of a nozzle of the extrusion mechanism defining a section of the object.

2. The method of claim 1, further comprising the step of depositing at least one successive section of the vesiculated extrusion bead aggregated to a previous section to form the object.

3. The method of claim 1, wherein the vesiculated extrusion bead is hollow, cavity-containing, aerated, or made to contain a volume of gas or liquid.

4. The method of claim 1, wherein the vesiculated extrusion bead is foamed.

5. The method of claim 1, wherein the step of extruding a vesiculated extrusion bead comprises extruding a hollow bead around at least one mandrel positioned within the nozzle of the extrusion mechanism.

6. The method of claim 1, wherein the step of extruding a vesiculated extrusion bead comprises introducing a vesiculating fluid through a port in the nozzle.

7. The method of claim 6, wherein the vesiculating fluid is a gas or liquid.

8. The method of claim 6, wherein the vesiculating fluid is produced by a physical or chemical blowing agent.

9. The method of claim 6, wherein introducing a vesiculating fluid further comprises controlling a temperature of the vesiculating fluid, thereby controlling a temperature of an interior of the vesiculated extrusion bead after being extruded.

10. The method of claim 6, wherein introducing a vesiculating fluid further comprises controlling the at least a pressure, flow rate, or temperature of at least the vesiculating fluid or the melted feedstock, thereby controlling at least a size or density of the vesiculated extrusion bead.

11. The method of claim 10, wherein controlling at least the size or density of the vesiculated extrusion bead further comprises utilizing a combination of vesiculated extrusion beads of differing sizes or densities to make at least one section of the object.

12. The method of claim 1, wherein the defined section of the object comprises a temporary or removable support for at least one section of the object.

13. The method of claim 1, wherein the feedstock includes preformed vesicles comprising hollow tubular, elongated, or spheroidal cavities that are incorporated into the vesiculated extrusion bead.

14. The method of claim 1, wherein the feedstock includes a dissolved gas, a chemical or a physical blowing agent.

15. The method of claim 1, wherein the feedstock includes preformed foam.

16. An extrusion assembly for an additive fabrication apparatus comprising:
a nozzle having an interior cavity;
an orifice positioned at an exit end of the nozzle; and
a means to introduce a vesiculating fluid comprising a liquid or a gas into an extrusion bead.

17. The assembly of claim 16, wherein the vesiculating fluid is produced by a physical or a chemical blowing agent.

18. The assembly of claim 16, wherein the nozzle further comprises a rapid-response heating element.

19. The assembly of claim 16, further comprising at least one mandrel positioned within the interior cavity of the nozzle.

20. The assembly of claim 16, wherein the means to introduce a vesiculating fluid comprises a tube having at least one port leading from the interior cavity of the nozzle to an exterior of the nozzle.

21. The assembly of claim 20, wherein the at least one port is positioned in the orifice.

22. The assembly of claim 20, wherein the at least one port is positioned inside of the interior cavity of the nozzle.

23. The assembly of claim 20, wherein the at least one port comprises a means of dispersing the vesiculating fluid.

24. The assembly of claim 20, wherein the interior cavity of the nozzle comprises a mixing chamber whereby the vesiculating fluid is distributed in the extrusion bead.

25. The assembly of claim 20, further comprising at least one mandrel positioned within the cavity of the nozzle, wherein the at least one port leading from the interior cavity of the nozzle to the exterior of the nozzle connects to a passage through an interior of the at least one mandrel to at least one opening located in the orifice.

26. The assembly of claim 20, further comprising a source of a vesiculating fluid connecting to the at least one port in the nozzle.

27. The assembly of claim 26, further comprising a means to control at least a pressure or a rate of flow of the vesiculating fluid.

28. The assembly of claim 26, further comprising a means to control a temperature of the vesiculating fluid.

29. A three dimensional object fabricated by an additive fabrication process comprising a plurality of vesiculated extrusion beads deposited in successive sections aggregated to form the three-dimensional object, wherein said vesiculated extrusion beads are hollow, cavity-containing, aerated, or made to contain a volume of gas or liquid.

30. The object of claim 29, wherein the additive fabrication process utilizes a computer controlled extrusion mechanism with an extrusion nozzle having means to produce the vesiculated extrusion beads.

31. The object of claim 29, wherein the three-dimensional object fabricated comprises an armature that is subsequently substantially covered or coated with another material, whereby the armature provides permanent or temporary structural support for the secondary material.
